(19) United States
(12) Patent Application Publication
(10) Pub. No.: US 2025/0026191 A1
(43) Pub. Date: Jan. 23, 2025

(54) COOLANT CIRCUIT FOR OPTIMIZED THERMAL MANAGEMENT FOR AN AT LEAST PARTIALLY ELECTRICALLY OPERATED MOTOR VEHICLE

(71) Applicant: AUDI AG, Ingolstadt (DE)

(72) Inventor: Philipp GRIESSL, Eggstätt (DE)

(73) Assignee: AUDI AG, Ingolstadt (DE)

(21) Appl. No.: 18/715,309

(22) PCT Filed: Sep. 7, 2022
(86) PCT No.: PCT/EP2022/074899

§ 371 Date: May 31, 2024

(30) Foreign Application Priority Data
Dec. 20, 2021 (DE) 10 2021 133 801.8

(51) Int. Cl. B60K 11/02; B60H 1/00; H01M 10/613; H01M 10/615; H01M 10/625; H01M 10/6568; H01M 10/6571; H01M 10/663

(52) U.S. Cl. CPC B60K 11/02; B60H 1/00278; H01M 10/613; H01M 10/615; H01M 10/625; H01M 10/6568; H01M 10/6571; H01M 10/663; B60H 2001/00307; H01M 2220/20

(57) ABSTRACT

A coolant circuit for an at least partially electrically operated motor vehicle includes a first coolant line with a first coolant pump, the first coolant line is connected to a battery storage device for cooling or heating the battery storage device. A second coolant line with a second coolant pump, the second coolant line is connected to further motor vehicle components. A heat exchanger is arranged in a heat exchanger section of the coolant circuit and is connected to a refrigerant circuit of the motor vehicle. An electrical heating element is arranged at a heating section of the coolant circuit and is designed to heat coolant circulating in the coolant circuit.

### FIELD

The invention relates to a coolant circuit for an at least partially electrically operated motor vehicle with a first coolant line with a first coolant pump, wherein the first coolant line is connected to a battery storage device for cooling or heating it; a second coolant line with a second coolant pump, wherein the second coolant line is connected to further motor vehicle components, in particular drive-side components, for cooling or heating them; a heat exchanger, in particular a chiller, which is arranged in a heat exchanger section of the coolant circuit and is connected to a coolant circuit of the motor vehicle; and with an electric heating element which is arranged on a heating section of the coolant circuit and is designed to heat coolant circulating in the coolant circuit as required.

### BACKGROUND

Various approaches to the structure of coolant circuits with heating elements are known from the prior art. For example, reference is made to US 2018 272 830 A1, US 2015 121 922 A1 and CN 111 731 068 A.

In such coolant circuits, mixing and switching valves are used to distribute the coolant volume flow as required to the components to be cooled or heated. The battery storage device is usually integrated using a switching valve, so that the battery storage device can only be integrated completely or not at all. Furthermore, the heating element is usually not multi-functional, but only serves to heat coolant for a specific component, such as the battery storage device.

### SUMMARY

The object of the invention is to provide a coolant circuit for an at least partially electrically operated motor vehicle, in which the heating element can be used in a variety of ways and the structure of the coolant circuit is simplified.

The proposal is therefore for a coolant circuit for an at least partially electrically operated motor vehicle with a first coolant line with a first coolant pump, wherein the first coolant line is connected to a battery storage device for cooling or heating the battery storage device;
a second coolant line with a second coolant pump, wherein the second coolant line is connected to further motor vehicle components, in particular drive-side components, for cooling or heating them;
a heat exchanger, in particular a chiller, which is arranged in a heat exchanger section of the coolant circuit and is connected to a refrigerant circuit of the motor vehicle;
an electrical heating element which is arranged at a heating section of the coolant circuit and is designed to heat coolant circulating in the coolant circuit as required.

It is provided that the first coolant line, the second coolant line and the heating section are connected to one another by means of a multi-way valve device.

By means of the multi-way valve device, it is possible to connect the heating section and thus the heating element with the various coolant lines, so that coolant heated by the heating element can be used in more than just one coolant line.

In this case, the multi-way valve device can be designed to connect the heating section to the first coolant line and/or to the second coolant line, so that coolant flows through the heating section and through the first coolant line and/or the second coolant line. In other words, the multi-way valve device can be adjusted so that the coolant volume flow either flows entirely through the first coolant line and the heating section or flows entirely through the second coolant line and the heating section. Furthermore, the multi-way valve device can also be adjusted so that respective partial volume flows can flow through the first and second coolant lines and the heating section.

In the coolant circuit, the multi-way valve device can be designed to separate the heating section from the first coolant line and the second coolant line, so that coolant flows through the first coolant line and/or the second coolant line, bypassing the heating section. The multi-way valve device can therefore be set in such a way that the heating section or heating element can be bypassed.

In the coolant circuit, a heat pump function can be enabled by means of the heat exchanger, in particular chiller, such that coolant circulating in the coolant circuit in the heat exchanger releases heat to the refrigerant of the refrigerant circuit. In other words, waste heat that is to be dissipated in the coolant circuit, for example from the battery storage device or drive-side components, can be transferred to the refrigerant of the refrigerant circuit in the heat exchanger.

In the coolant circuit, the heat exchanger, in particular chiller, can be arranged between the multi-valve device and the second coolant pump.

The coolant circuit can have multiple connecting sections which fluidically connect the first coolant line, the second coolant line, the heating section and the heat exchanger section. For example, a connecting section can branch off downstream of the heat exchanger and upstream of the second coolant pump, which serves as a bypass section for the second coolant line. This makes it possible to prevent the flow of the second refrigerant line if necessary.

In the coolant circuit, the first coolant line can have a flushing section that branches off downstream from the battery storage device and opens upstream from the first coolant pump. This enables an optional flushing function for the battery storage device, depending on the position of the multi-way valve device.

In the coolant circuit, the multi-way valve device can have at least three valve connections, wherein a first valve connection is connected to the heating section, a second valve connection is connected to the first coolant line and a third valve connection is connected to the heat exchanger section.

A motor vehicle with at least partially electric drive can have a coolant circuit as described above. The motor vehicle usually also has a refrigerant circuit used for interior air conditioning. This refrigerant circuit is in thermal connection with the coolant circuit by means of the heat exchanger, in particular the chiller.

### BRIEF DESCRIPTION OF THE FIGURES

Further advantages and details of the invention result from the following description of embodiments with reference to the figures. In the figures:

FIG. 1 is a simplified and schematic representation of a coolant circuit in a motor vehicle;

FIG. 2 is a schematic and simplified representation of a multi-way valve device for the coolant circuit;

FIG. 3 is a schematic and simplified diagram illustrating different opening positions of the multi-way valve device;

FIG. 4 is an example of an operating state of the coolant circuit;

FIG. 5 is an example of an operating state of the coolant circuit;

FIG. 6 is an example of an operating state of the coolant circuit;

FIG. 7 is an example of an operating state of the coolant circuit;

FIG. 8 is an example of an operating state of the coolant circuit;

### DETAILED DESCRIPTION

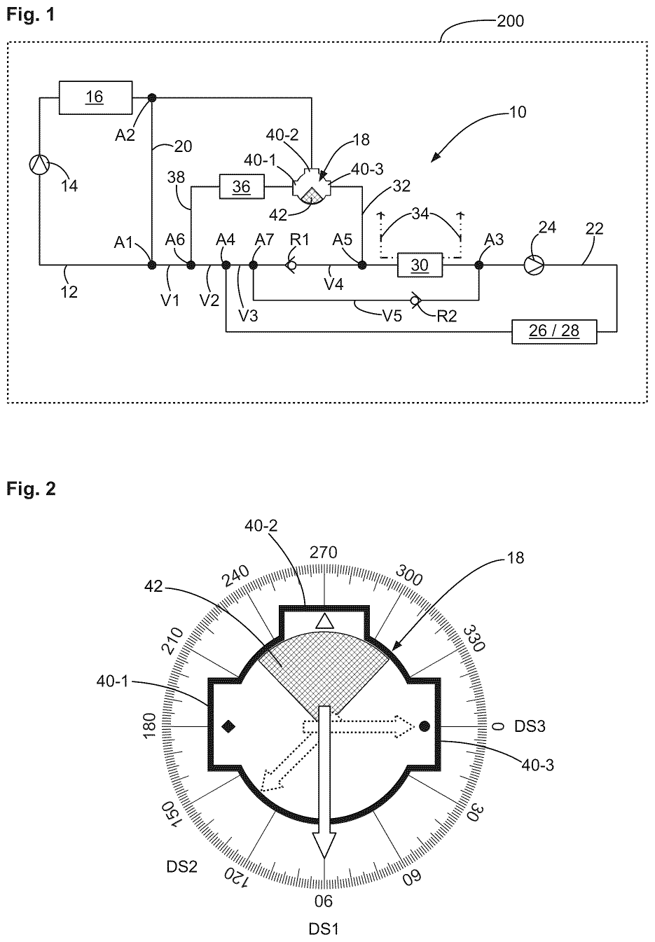

FIG. 1 shows a simplified and schematic topology of a coolant circuit 10. Such a coolant circuit 10 can be used in an at least partially electrically operated motor vehicle 200, such as a hybrid vehicle or an electric vehicle, which is illustrated in FIG. 1 by the dashed rectangle.

The coolant circuit 10 has a first coolant line 12 with a first coolant pump 14, wherein the first coolant line 12 is connected to a battery storage device 16 for cooling or heating the battery storage device.

In this exemplary topology, the first coolant line 12 begins at a branch A1 and ends at a multi-way valve device 18, which will be described in more detail later. Optionally, the first coolant line 12 can have a flushing section 20, which branches off downstream from the battery storage device 16 (branch A2) and opens upstream from the first coolant pump 14 (at branch A1).

The coolant circuit 10 has a second coolant line 22 with a second coolant pump 24, wherein the second coolant line 22 is connected to further motor vehicle components 26, in particular drive-side components such as electric motor(s), control units, etc. for their cooling or heating. The second coolant line 22 usually also includes a cooler 28, which is shown here in a simplified and schematic manner together with the motor vehicle components 26.

In this exemplary topology, the second coolant line 22 begins at a branch A3 and ends at a branch A4.

The coolant circuit 10 has a heat exchanger 30, which can also be referred to as a chiller. The heat exchanger 30 is arranged in a heat exchanger section 32 of the coolant circuit. Furthermore, it is connected to a refrigerant circuit 34 of the motor vehicle 200, which is only indicated here.

In this exemplary topology, the heat exchanger section 32 begins at the multi-way valve device 18 and ends at branch A3. As already mentioned above, the second coolant line 22 begins at branch A3. In other words, it can also be said that the heat exchanger 30 is arranged between the multi-valve device 18 and the second coolant pump 24.

In this example, the heat exchanger section 32 also has a branch A5, which is arranged in the flow direction of coolant between the multi-way valve device 18 and the heat exchanger 30.

The coolant circuit 10 further comprises an electrical heating element 36 which is arranged on a heating section 38 of the coolant circuit 10. The heating element 36 is designed to heat coolant circulating in the coolant circuit 10 as required.

In this exemplary topology, the heating section 38 extends between the multi-way valve device 18 and a branch A6. In the example shown, branch A6 is provided upstream of branch A1, where the first coolant line 12 begins.

In this exemplary topology, the first coolant line 12, the second coolant line 22 and the heating section 38 are connected to one another by means of the multi-way valve device 18 already mentioned.

In coolant circuit 10 the multi-way valve device 18 is designed to connect the heating section 38 to the first coolant line 12 and/or to the second coolant line 22, so that coolant flows through the heating section 38 and through the first coolant line 12 and/or the second coolant line 22.

Furthermore, the multi-way valve device 18 is designed to separate the heating section 38 from the first coolant line 12 and the second coolant line 22, so that coolant flows through the first coolant line 12 and/or the second coolant line 22, bypassing the heating section 38.

In the exemplary topology, the coolant circuit 10 has multiple connecting sections V1 to V5, which fluidically connect the first coolant line 12, the second coolant line 22, the heating section 38 and the heat exchanger section 32 to one another.

In the example topology, the connection section V1 extends between the branches A1 and A6.

In the example topology, the connection section V2 extends between the branches A4 and A6.

In the example topology, the connection section V3 extends between branch A4 and branch A7.

In the example topology, the connection section V4 extends from branch A7 to branch A5.

In the example topology, the connection section V5 extends between from branch A3 to branch A7. In other words, the connecting section V5 branches off downstream from the heat exchanger 30 and upstream from the second coolant pump 24, so that it serves as a bypass section for the second coolant line 22 or the components 26 or the cooler 28.

Please note that the number of branches A1 to A7 and connecting sections V1 to V5 shown here is not to be understood as limiting. However, the chosen type of exemplary representation of the topology of the coolant circuit 10 makes it possible to describe the mode of operation precisely because each line section of the coolant circuit 10 can be addressed.

In particular, in the case of branches A1 to A7 and the connecting sections V1 to V5, it is of course possible for two or more branches to be combined when implementing a coolant circuit 10. For example, it is conceivable that the branches A4 and A7 illustrated individually here could be combined with each other, whereby the connecting section V5 could then flow into branch A4, so that branch A7 could be omitted. This would also eliminate the connection section V3, even if the basic flow structure of the coolant circuit 10 remains unchanged.

For the sake of completeness, it is pointed out that two optional check valves R1 and R2 are shown in the exemplary topology of the coolant circuit 10. The check valve R1 is arranged between the two coolant lines 12, 22, in particular it is provided in the connecting section V4, wherein it is arranged upstream of the branch A5. The check valve R2 is located in the connecting section V5 (bypass section) between the branches A3 and A7. Of course, further or other valve devices can be provided in the coolant circuit 10, but these are not shown in detail here.

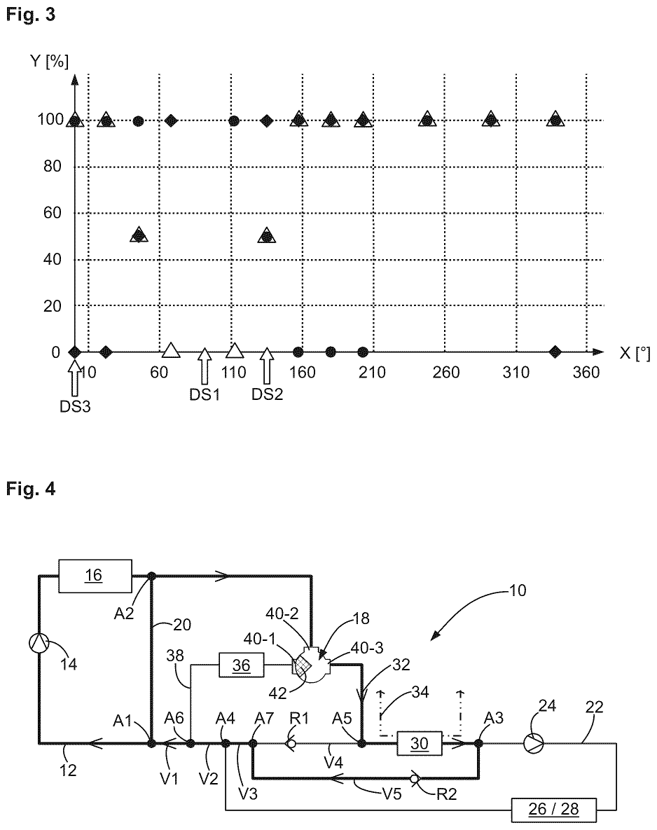

The operation of the multi-way valve device is described in more detail below with reference to FIGS. 2 and 3.

FIG. 2 shows a simplified and schematic view of a multi-way valve device 18 which can be used in a coolant circuit 10 as described above. The multi-way valve device 18 comprises, for example, three valve connections 40-1, 40-2 and 40-3.

The valve connections 40-1, 40-2, 40-3 are arranged, for example, along a circle, with an angle of approximately 90° being formed between the valve connections 40-1, 40-2 and 40-2, 40-3. An angle of approximately 180° is formed between the valve connections 40-1 and 40-3. The arrangement of valve connections 40-1, 40-2, 40-3 relative to one another can also be designed with other angles in a specific embodiment of a multi-way valve device.

The multi-way valve device 18 comprises a slide device 42 which is designed to completely or partially open or close the valve connections 40-1, 40-2, 40-3. The slide device 42 can be adjusted to different switching positions along a circle.

The slide device 42 has a circular sector-shaped or ring sector-shaped design such that a valve connection 40-1, 40-2, 40-3 can be sealed by means of an outer peripheral surface 44 of the slide device 42.

FIG. 3 shows in a simplified diagram at which rotational position of the slide device 42 which valve connection 40-1, 40-2, 40-3 is (partially) opened or (partially) closed. The black square is assigned to valve connection 40-1. The unfilled contour triangle is assigned to the valve connection 40-2. The black circle or dot is assigned to valve connection 40-3.

In the diagram, rotational positions in degrees [°] are entered on the X-axis. On the Y-axis, the opening degree of the valve devices 40-1, 40-2, 40-3 is indicated in percent [%].

If, for example, one takes the rotational position of FIG. 2, in which the slide device 42 is positioned in a 90° rotational position DS1 (vertical, solid line in FIG. 3), the following can be taken from the diagram of FIG. 3, but of course also from FIG. 2: The valve connection 40-2 is completely closed (opening degree 0%) and the valve connections 40-1 and 40-3 are completely open (opening degree 100%).

If the slide device 42 is set, for example, to a rotational position DS2 of approximately 135°, the valve connections 40-2 and 40-3 are partially opened (respective opening degree 50%). The valve connection 40-1 is completely open (opening degree 100%).

If the slide device 42 is set to a rotational position DS3 of approximately 0°, the valve connections 40-2 and 40-3 are completely open (respective opening degree 100%). The valve connection 40-1 is completely closed (opening degree 0%).

The rotary positions DS1. DS2. DS3 are indicated in FIG. 2 and Fig. by respective (dashed) contour arrows. In FIG. 2, the slide device 42 is shown only in the rotational position DS1. However, it is self-explanatory how the slide device 42 must be aligned for the rotary positions DS2 and DS3, taking into account the respective associated dashed contour arrow. It is pointed out that in FIGS. 2 and 3 the (dashed) contour arrows serve only to illustrate the rotational positions DS1, DS2 and DS3, as does the angular division contained in FIG. 2.

From the explanations of FIGS. 2 and 3 regarding the functioning of the multi-way valve device 18, it is clear that different operating states for the coolant circuit 10 can be set by means of the multi-way valve device 18. The multi-way valve device 18 is designed in such a way that it can be used not only as a switching valve, but also as a mixing valve.

As can be seen from the combination of FIGS. 1 and 2, the first valve connection 40-1 is connected to the heating section 36. The second valve connection 40-2 is connected to the first coolant line 12. The third valve connection 40-3 is connected to the heat exchanger section 32.

Various operating states for the coolant circuit 10 are explained below with reference to FIGS. 4 to 8. Active line sections of the coolant circuit are shown with thicker black lines compared to FIG. 1.

FIG. 4 shows an operating state in which the slide device 42 of the multi-way valve device 18 is set in the rotary position DS3. In other words, valve connection 40-1 is closed and valve connections 40-2 and 40-3 are (fully) open. In such an operating state, the battery storage device 16 can be (actively) cooled. The coolant is circulated by the first coolant pump 14. Downstream from the battery storage device 16, the coolant flows through the multi-way valve device 18 and then the heat exchanger 30. There, the coolant can release heat to the refrigerant circuit 34 of the motor vehicle. The second coolant pump 24 is inactive in this operating state. In particular, it inhibits a flow of coolant through the second coolant line 22. Additionally or alternatively, a valve device could be arranged downstream of the branch A3 and of the second coolant pump 24 in order to switch the second coolant line 22 inactive or to decouple it.

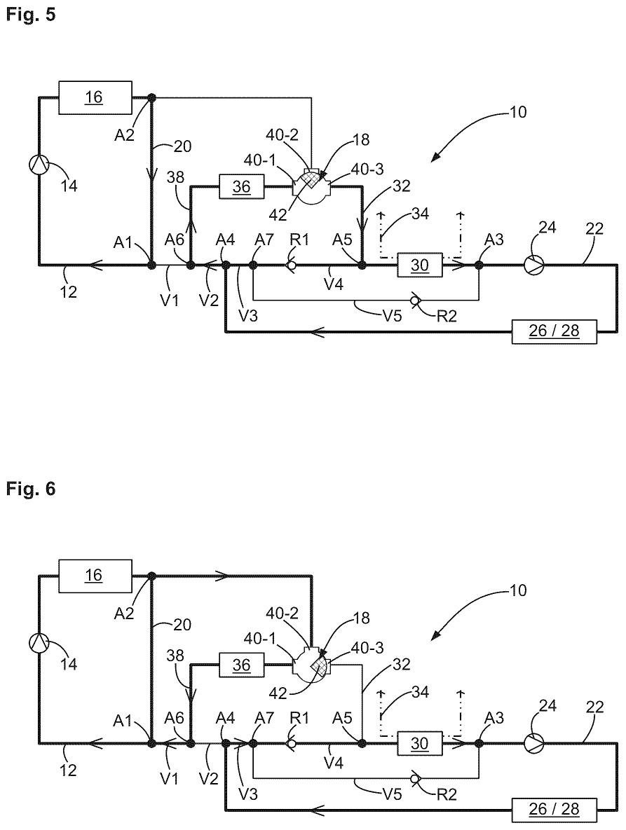

FIG. 5 shows an operating state in which the slide device 42 of the multi-way valve device 18 is set in the rotary position DS1. In other words, valve connection 40-2 is closed and valve connections 40-1 and 40-3 are (fully) open.

In such an operating state of FIG. 5, the heat exchanger 30 is used as a heat pump to transfer heat dissipated from the second coolant line 22, in particular the components 26, to the refrigerant circuit 34. The second coolant pump 24 is activated. In this operating state, it is possible to additionally heat the coolant by means of the heating element 36 before it passes through the heat exchanger 30. Thus, if the components 26 do not give off sufficient heat or if sufficient heat cannot be extracted from the ambient air at the cooler 28, the coolant can be heated using the heating element 36.

In this operating state of FIG. 5, the first coolant pump 14 can also be activated. The coolant then circulates downstream from the battery storage device 16 through the flushing section 20. In this configuration, the battery storage device 16 can be flushed.

FIG. 6 shows an operating state in which the slide device 42 of the multi-way valve device 18 is set in the rotary position of about 180°. In other words, valve connection 40-3 is closed and valve connections 40-1 and 40-2 are (fully) open.

In this operating state of FIG. 6, the first coolant pump 14 is activated and the coolant circulates downstream from the battery storage device 16 through the multi-way valve device 18 and the heating section 38 or the heating element 36. Thus, the coolant circulating in the first coolant line 12 can be heated by means of the heating element 36. In other words, in this operating state, the battery storage device 16 can be heated as needed by the coolant heated at the heating element 36.

In this operating state of FIG. 6, the second coolant pump 24 is also activated. The coolant circulates in the second coolant line 22 and through the heat exchanger 30. Thus, heat generated at the components 26 can be dissipated and the heat exchanger 30 can be operated as a heat pump in the refrigerant circuit 34 of the motor vehicle. In other words, the components 26 and/or the ambient air at the cooler can serve as heat sources to heat the coolant so that heat can be transferred to the refrigerant circuit 34 at the heat exchanger. Furthermore, heating of the battery storage device 16 can also be carried out in this operating state.

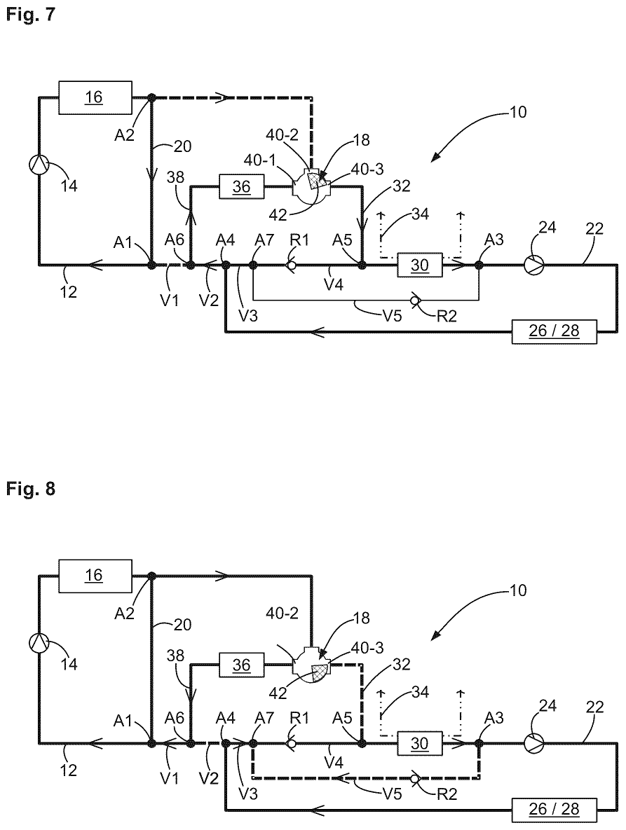

FIG. 7 shows an operating state in which the slide device 42 of the multi-way valve device 18 is set in the rotary position DS1. In other words, valve connection 40-1 is fully open and valve connections 40-2 and 40-3 are partially open.

In such an operating state of FIG. 7, the heating element 36 can be used to additionally heat coolant for the second coolant line 22 and the heat exchanger 30, so that the heat pump function at the heat exchanger 30 can be supported. However, the heating element 36 can also be used at the same time to heat coolant that circulates in the first coolant line 12, so that the battery storage device can also be warmed or heated.

FIG. 8 shows an operating state in which the slide device 42 of the multi-way valve device 18 is set in a rotary position of about 225°. In other words, valve connection 40-3 is partially open and valve connections 40-1 and 40-2 are completely open.

In this operating state of FIG. 8, the heating element 36 serves primarily to heat the battery storage device 16, roughly comparable to the operating state of FIG. 6. Furthermore, the heat pump function is implemented in the second coolant line 22 by incorporating the heat exchanger 30, also comparable to the operating state of FIG. 6. Due to the setting of the multi-way valve device 18, however, an exchange of coolant between the two coolant lines 12, 22 can also be made possible in this operating state. In particular, the heat requirement for the heat pump function or the battery heating can be optimally adjusted or regulated by means of the multi-valve device 18.

Referring to the various operating states shown above in FIGS. 4 to 8, a heat pump function can be enabled in the coolant circuit 10 by means of the heat exchanger 30, such that coolant circulating in the coolant circuit 10 in the heat exchanger 30 releases heat to the refrigerant of the refrigerant circuit 34.

1-10. (canceled)

11. A coolant circuit for an at least partially electrically operated motor vehicle, comprising:
a first coolant line with a first coolant pump, wherein the first coolant line is connected to a battery storage device for cooling or heating the battery storage device;
a second coolant line with a second coolant pump, wherein the second coolant line is connected to further motor vehicle components, in particular drive-side components, for cooling or heating them;
a heat exchanger, in particular a chiller, which is arranged in a heat exchanger section of the coolant circuit and is connected to a refrigerant circuit of the motor vehicle;
an electrical heating element which is arranged at a heating section of the coolant circuit and is designed to heat coolant circulating in the coolant circuit as required, wherein the first coolant line, the second coolant line and the heating section are connected to one another by means of a multi-way valve device.

12. The coolant circuit according to claim 11, wherein the multi-way valve device can be designed to connect the heating section to the first coolant line and/or to the second coolant line, so that coolant flows through the heating section and through the first coolant line and/or the second coolant line.

13. The coolant circuit according to claim 11, wherein the multi-way valve device can be designed to connect the heating section to the first coolant line and/or to the second coolant line, so that coolant flows through the heating section and through the first coolant line and/or the second coolant line.

14. The coolant circuit according to claim 11, wherein a heat pump function is made possible by means of the heat exchanger, in particular chiller, such that coolant circulating in the coolant circuit in the heat exchanger releases heat to the refrigerant of the refrigerant circuit.

15. The coolant circuit according to claim 11, wherein the heat exchanger, in particular chiller, is arranged between the multi-valve device and the second coolant pump.

16. The coolant circuit according to claim 11, further comprising: multiple connecting sections which fluidically connect the first coolant line, the second coolant line, the heating section and the heat exchanger section to one another.

17. The coolant circuit according to claim 16, wherein, downstream of the heat exchanger and upstream of the second coolant pump, a connecting section branches off, which serves as a bypass section for the second coolant line.

18. The coolant circuit according to claim 11, wherein the first coolant line has a flushing section which branches off downstream from the battery storage device and opens upstream from the first coolant pump.

19. The coolant circuit according to claim 11, wherein the multi-way valve device has at least three valve connections, wherein a first valve connection is connected to the heating section, a second valve connection is connected to the first coolant line and a third valve connection is connected to the heat exchanger section.

20. A motor vehicle with at least partially electric drive and a coolant circuit according to claim 11.

21. The coolant circuit according to claim 12, wherein the multi-way valve device can be designed to connect the heating section to the first coolant line and/or to the second coolant line, so that coolant flows through the heating section and through the first coolant line and/or the second coolant line.

22. The coolant circuit according to claim 12, wherein a heat pump function is made possible by means of the heat exchanger, in particular chiller, such that coolant circulating in the coolant circuit in the heat exchanger releases heat to the refrigerant of the refrigerant circuit.

23. The coolant circuit according to claim 13, wherein a heat pump function is made possible by means of the heat exchanger, in particular chiller, such that coolant circulating in the coolant circuit in the heat exchanger releases heat to the refrigerant of the refrigerant circuit.

24. The coolant circuit according to claim 12, wherein the heat exchanger, in particular chiller, is arranged between the multi-valve device and the second coolant pump.

25. The coolant circuit according to claim 13, wherein the heat exchanger, in particular chiller, is arranged between the multi-valve device and the second coolant pump.

26. The coolant circuit according to claim 14, wherein the heat exchanger, in particular chiller, is arranged between the multi-valve device and the second coolant pump.

27. The coolant circuit according to claim 12, further comprising: multiple connecting sections which fluidically connect the first coolant line, the second coolant line, the heating section and the heat exchanger section to one another.

28. The coolant circuit according to claim 13, further comprising: multiple connecting sections which fluidically connect the first coolant line, the second coolant line, the heating section and the heat exchanger section to one another.

29. The coolant circuit according to claim 14, further comprising: multiple connecting sections which fluidically connect the first coolant line, the second coolant line, the heating section and the heat exchanger section to one another.

30. The coolant circuit according to claim 15, further comprising: multiple connecting sections which fluidically connect the first coolant line, the second coolant line, the heating section and the heat exchanger section to one another.
